(19) United States
(12) Patent Application Publication
(10) Pub. No.: US 2022/0156110 A1
(43) Pub. Date: May 19, 2022

(54) INFORMATION PROCESSING DEVICE, INFORMATION PROCESSING SYSTEM, NON-TRANSITORY RECORDING MEDIUM, AND INFORMATION PROCESSING METHOD

(71) Applicant: Yoshihisa Matsukawa, Chiba (JP)

(72) Inventor: Yoshihisa Matsukawa, Chiba (JP)

(73) Assignee: Ricoh Company, Ltd., Tokyo (JP)

(21) Appl. No.: 17/453,233

(22) Filed: Nov. 2, 2021

(30) Foreign Application Priority Data
Nov. 18, 2020 (JP) 2020-191818

(51) Int. Cl. G06F 9/48

(52) U.S. Cl. CPC G06F 9/4843

(57) ABSTRACT

An information processing device includes circuitry to create, in an application execution environment, a container to provide a service. The application execution environment is used to provide the service and managed by units of containers. The circuitry causes the container to execute processing to provide the service and causes another device to record an execution time in association with identification information a user group. The execution time is a period of time during which the container executes the processing. The circuitry further obtains an amount value corresponding to usage of the service for the user group based on the execution time associated with the identification information of the user group.

### CROSS-REFERENCE TO RELATED APPLICATION

This patent application is based on and claims priority pursuant to 35 U.S.C. § 119(a) to Japanese Patent Application No. 2020-191818, filed on Nov. 18, 2020, in the Japan Patent Office, the entire disclosure of which is hereby incorporated by reference.

### BACKGROUND

### Technical Field

Embodiments of the present disclosure relate to an information processing device, an information processing system, a non-transitory recording medium, and an information processing method.

### Related Art

There are known services that provide a report function of reporting a usage record of an apparatus such as a multifunction peripheral (MFP) by causing the apparatus to be cooperated with the cloud. In general, to use such a service of report function, a fee for usage of such the service of report function is charged. For example, a charging system having flexibility in charging for a fee for usage of an apparatus is conventionally known.

### SUMMARY

An embodiment of the present disclosure includes an information processing device including circuitry to create, in an application execution environment, a container to provide a service to one or more user groups. The application execution environment is used to provide the service and managed in a unit of one container. The circuitry causes the container to execute processing to provide the service and causes another device to record an execution time in association with identification information a user group. The execution time is a period of time during which the container executes the processing. The circuitry further obtains an amount value corresponding to usage of the service for the user group based on the execution time associated with the identification information of the user group.

An embodiment of the present disclosure includes a non-transitory recording medium storing a plurality of instructions which, when executed by one or more processors, causes the processors to perform a method. The method includes creating, in an application execution environment, a container to provide a service. The application execution environment is used to provide the service and managed in a unit of one container. The method further includes causing the container to execute processing to provide the service and causing a device to record an execution time in association with identification information of a user group. The execution time is a period of time during which the container executes the processing. The method further includes obtaining an amount value corresponding to usage of the service for the user group based on the execution time associated with the identification information of the user group.

An embodiment of the present disclosure includes a method including creating, in an application execution environment, a container to provide a service. The application execution environment is used to provide the service and managed in a unit of one container. The method further includes causing the container to execute processing to provide the service and causing a device to record an execution time in association with identification information of a user group. The execution time is a period of time during which the container executes the processing. The method further includes obtaining an amount value corresponding to usage of the service for the user group based on the execution time associated with the identification information of the group.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of an information processing system according to an exemplary embodiment of the disclosure;

FIG. 2 is a block diagram illustrating an example of a hardware configuration of a computer according to the exemplary embodiment of the disclosure;

FIG. 3 is a block diagram illustrating an example of a configuration of an application execution environment that uses a virtual container technology, according to the exemplary embodiment of the disclosure;

FIG. 4 is a block diagram illustrating an example of a functional configuration a report generation service providing server according to the exemplary embodiment of the disclosure;

FIG. 5 is a sequence diagram illustrating an example of a process in which the information processing system records an execution time of a report generating container in association with a tenant identification information (ID), according to the exemplary embodiment of the disclosure;

FIG. 6 is a diagram illustrating an example of a table recorded by a container execution time collection server according to the exemplary embodiment of the disclosure;

FIG. 7 is a flowchart illustrating an example of a process in which the information processing system calculates a fee for a report function for each tenant ID, according to the exemplary embodiment of the disclosure; and

FIG. 8 is a diagram illustrating an example of a table of an execution time of the report function of a current month calculated by a container execution time calculation unit according to the exemplary embodiment of the disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

An exemplary embodiment of the present disclosure is described below with reference to the attached drawings. In the exemplary embodiment given below, a function of reporting a usage record (usage result) of an apparatus is described as an example of a service. The function of reporting may be referred to as a report function. The service may be another service.

System Configuration:

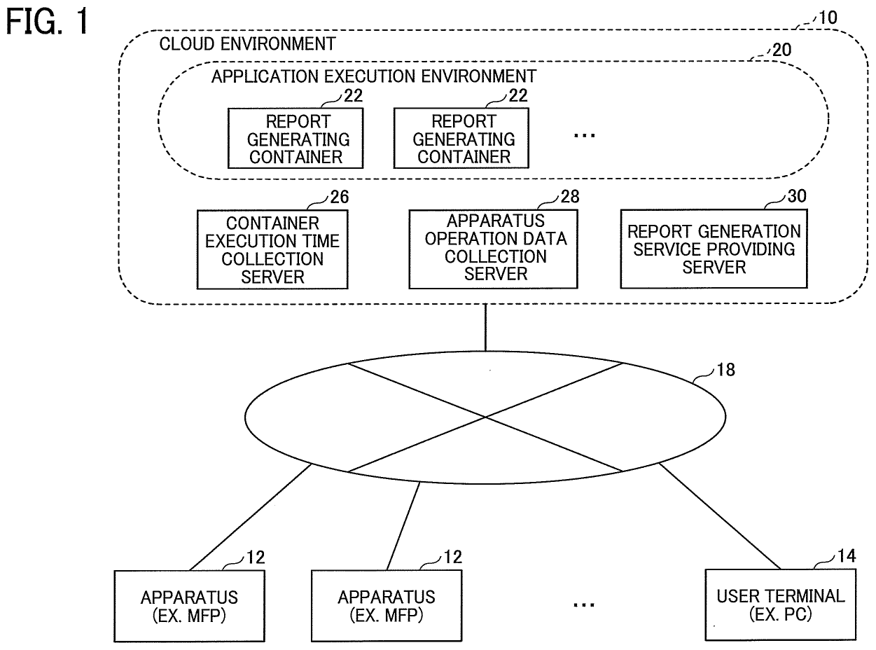

FIG. 1 is a schematic diagram illustrating a configuration of an information processing system according to the exemplary embodiment. The information processing system illustrated in FIG. 1 includes a cloud environment 10, one or more apparatuses 12, and a user terminal 14. The cloud environment 10, the one or more apparatuses 12, and the user terminal 14 communicate with each other via a network 18. The network 18 includes, for example, the Internet and a local area network (LAN).

The cloud environment 10 is implemented by one or more information processing devices. The cloud environment 10 has an application execution environment 20. The cloud environment 10 includes a container execution time collection server (execution time collection device) 26, an apparatus operation data collection server (apparatus operation data collection device) 28, and a report generation service providing server 30. The cloud environment 10 provides computer resources in a form of service via the network 18.

The application execution environment 20 is an application execution environment using a virtual container technology. The application execution environment 20 is managed in units of containers such as report generating containers 22. A detailed description of the application execution environment 20 is described later.

The container execution time collection server 26 records, or stores, (holds) a period of time during which a container such as the report generating container 22 executes processing in the application execution environment 20 in association with identification information that identifies an organization. In the following description, the period of time during which a container such as the report generating container 22 executes processing may be referred to as an execution time. The identification that identifies an organization includes a tenant ID. In the following description, a tenant is a customer unit, more specifically, a unit of users belonging to a group as a customer, such as a company or an organization that has a contract, or license, to use the service. The group is also referred to as a user group. The “tenant” and the “tenant ID” may be replaced by a “customer (customer unit)” or “user group” and a “customer ID” or “user group ID,” respectively. The apparatus operation data collection server 28 collects and holds apparatus operation data (usage status, operating status) of the apparatus 12 associated with the tenant ID.

The report generation service providing server 30 receives, for example, a request to generate a report on a usage record of the apparatus 12 from the apparatus 12 or the user terminal 14 operated by a user, according to a user operation. In the following description, the request may be referred to as a usage record report generating request or a report generating request. The usage record report generating request in relation to the apparatus 12 is an example of a use request that is a request for using a service using the application execution environment 20. In response to receiving the report generating request according to the user operation, the report generation service providing server 30 creates the report generating container 22 in the application execution environment 20 and causes the report generating container 22 to generate a report. The report generating container 22 generates the report on the usage record of the apparatus 12 based on the apparatus operation data of the apparatus 12 held by (stored in) the apparatus operation data collection server 28. When the report generating container 22 completes generation of the report, the report generation service providing server 30 discards, or deletes, the report generating container 22, which has completed the generation of the report.

In addition, the report generation service providing server 30 calculates a fee for a report function for each predetermined period (for example, one month) based on each execution time recorded by the container execution time collection server 26 in association with the tenant ID, and presents the fee to the user through a user interface (UI). Calculating the fee for the report function corresponds to obtaining an amount value of usage of the service corresponding to the report function in the description of the present embodiment.

The apparatus 12 is an electronic apparatus that is a subject to generate a usage record report. The apparatus 12 is, for example, an image forming apparatus such as a facsimile communication (FAX) device, a scanner device, or a Multifunction Peripheral/Product/Printer (MFP). The user terminal 14 is a terminal device operated by a user, and is, for example, a personal computer (PC). The user terminal 14 may be a mobile phone, a smartphone, a tablet terminal, a game machine, or a personal digital assistant (PDA). Each of the apparatus 12 and the user terminal 14 is an example of a device that receives a report generating request from a user and presents a fee for a report function on a UI.

The configuration of the information processing system illustrated in FIG. 1 is an example. For example, the configuration having segmentation of the container execution time collection server 26, the apparatus operation data collection server 28, and the report generation service providing server 30 in FIG. 1 is an example, and may have different segmentation. Alternatively, these servers may be integrated into one server. In addition, the container execution time collection server 26, the apparatus operation data collection server 28, and the report generation service providing server 30 in FIG. 1 may not be implemented in the cloud environment 10, and may be implemented by, for example, on-premises.

Hardware Configuration:

Hardware Configuration of Computer:

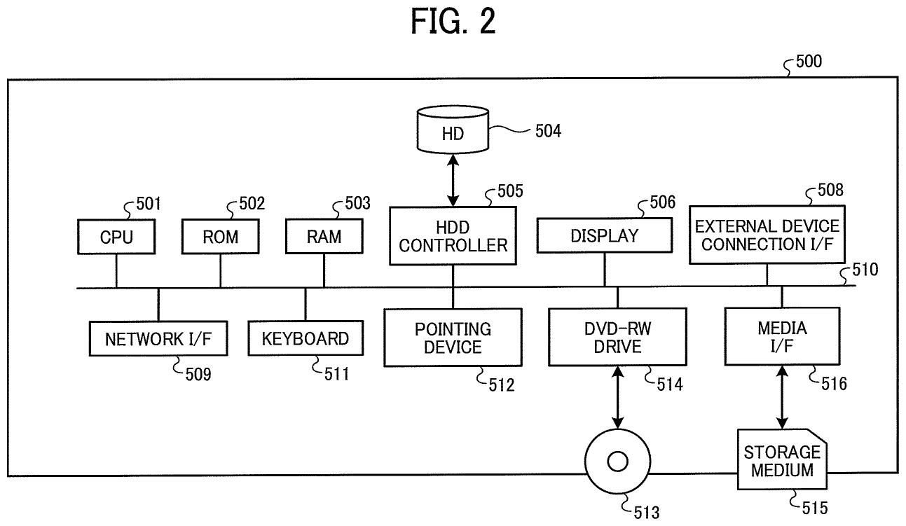

Each of the application execution environment 20, the container execution time collection server 26, the apparatus operation data collection server 28, and the report generation service providing server 30 of the cloud environment 10 illustrated in FIG. 1 is implemented by, for example, the computer 500 having a hardware configuration illustrated in FIG. 2. The user terminal 14 illustrated in FIG. 1 is implemented by the computer 500 having a hardware configuration as illustrated in FIG. 2, for example. FIG. 2 is a block diagram illustrating an example of a hardware configuration of a computer according to the present embodiment.

The computer 500 includes a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network I/F 509, a data bus 510, a keyboard 511, a pointing device 512, a digital versatile disk rewritable (DVD-RW) drive 514, and a media I/F 516.

Among these elements, the CPU 501 performs overall control of the computer 500 according to a program. The ROM 502 stores a program such as an Initial Program Loader (IPL) used for driving the CPU 501. The RAM 503 is used as a work area for the CPU 501. The HD 504 stores various data such as a program. The HDD controller 505 controls reading and writing of various data from and to the HD 504 under control of the CPU 501.

The display 506 displays various information such as a cursor, a menu, a window, a character, or an image. The external device I/F 508 is an interface for connecting various external devices. The external device in this case is, for example, a Universal Serial Bus (USB) memory. The network I/F 509 is an interface for data communication using the network 18. Examples of the data bus 510 include, but not limited to, an address bus and a data bus, which electrically connects the components, such as the CPU 501, with one another.

The keyboard 511 is one example of an input device provided with a plurality of keys for allowing a user to input characters, numerals, or various instructions. The pointing device 512 is an example of an input device that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a Digital Versatile Disc-Recordable (DVD-R) or the like. The media I/F 516 controls reading and writing (storing) of data from and to a storage medium 515 such as a flash memory.

Configuration of Application Execution Environment:

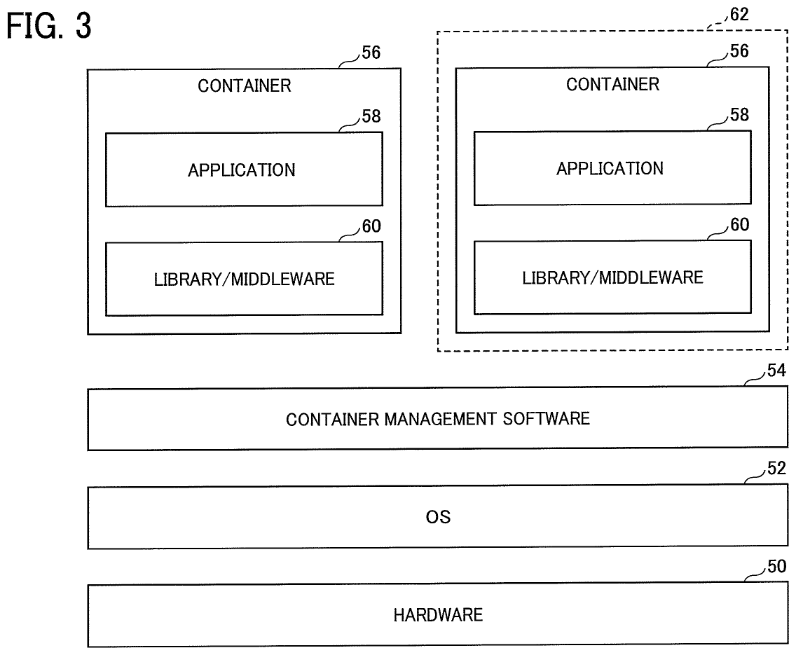

FIG. 3 is a block diagram illustrating an example of a configuration of an application execution environment that uses a virtual container technology, according to the present embodiment. The application execution environment 20, which uses a virtual container technology, virtualizes an Operating System (OS) 52 on hardware 50 of a host machine by container management software 54. The container management software 54 creates one or more containers 56 as an application execution environment 62 unavailable by other users on the OS 52, which is a single OS. DOCKER (Registered Trademark) is an example of the container management software 54.

An application 58 and a library/middleware 60 are managed for each container 56 by the container management software 54. According to the application execution environment 20 of FIG. 3, the report function using the application execution environment 20 may be provided to the user as a service in units of containers 56.

Functional Configuration:

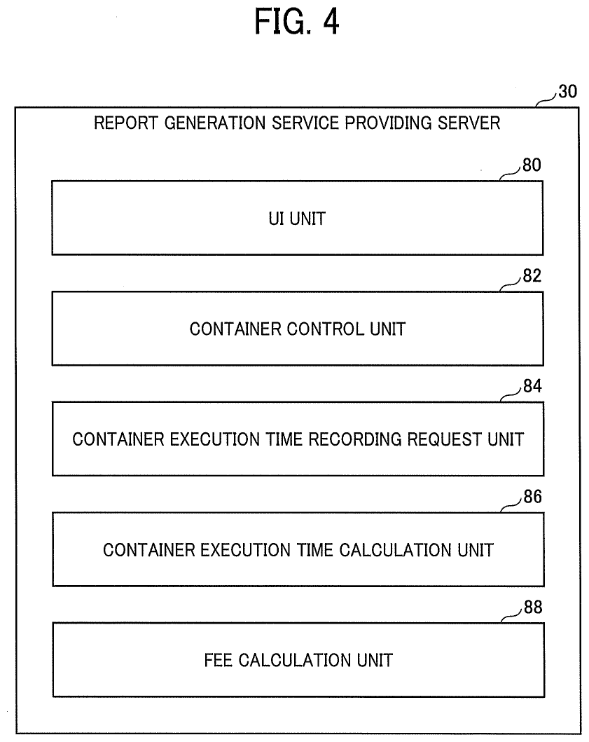

The report generation service providing server 30 of the information processing system 1 according to the present embodiment is implemented by a functional configuration as illustrated in FIG. 4, for example. FIG. 4 is a block diagram illustrating an example of a functional configuration the report generation service providing server 30 according to the present embodiment. In the functional configuration of FIG. 4, some components unnecessary for the description of the present embodiment are omitted for simplicity.

The report generation service providing server 30 of FIG. 4 includes a UI unit 80, a container control unit 82, a container execution time recording request unit 84, a container execution time calculation unit 86, and a fee calculation unit 88.

The UI unit 80 provides a UI to the apparatus 12 or the user terminal 14. The container control unit 82 performs control for creating the container 56 in the application execution environment 20, control for causing the container 56 to execute processing, and control for discarding, or deleting, the container 56 that has completed the processing, for example.

The container execution time recording request unit 84 causes the container execution time collection server 26 to record a period of time during which the container 56 executes the processing in the application execution environment 20 in association with, for example, a tenant ID.

The container execution time calculation unit 86 calculates an execution time that is a total execution time of the report function in a predetermined period (for example, a current month) for each tenant ID (each of one or more user groups (user group IDs)) based on each execution time recorded by the container execution time collection server 26 in association with the corresponding tenant ID. The fee calculation unit 88 calculates a fee for the report function of the current month, for example, based on the execution time (total execution time) of the report function of the current month. For example, the fee for the report function corresponds to an amount value corresponding to usage of the report function.

The UI unit 80 in FIG. 4 is implemented by, for example, instructions from the CPU 501 of FIG. 2, the keyboard 511, the pointing devices 512, or the display 506. The container control unit 82, the container execution time record request unit 84, the container execution time calculation unit 86, and the fee calculation unit 88 are implemented, for example, by the CPU 501, which is illustrated in FIG. 2, executing processing according to a program using RAM 503 as a work area.

Process:

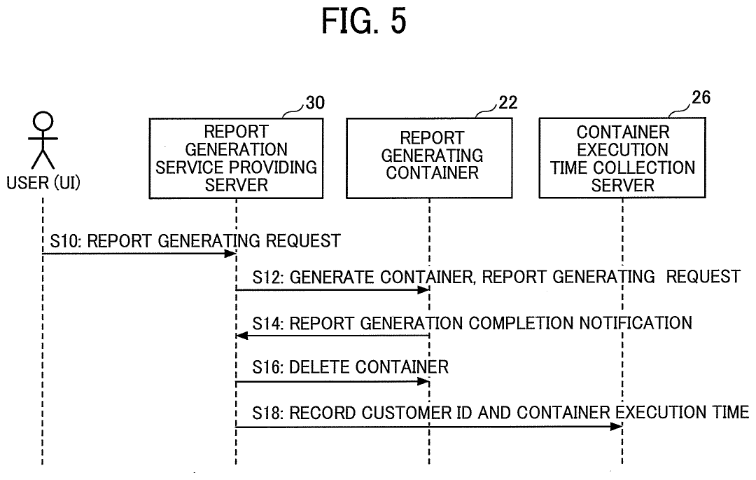

In the information processing system according to the present embodiment, the execution time during which the report generating container 22 executes the report function is recorded in the container execution time collection server 26 for each tenant ID (each of one or more user groups (user group IDs)), and an example of this process is illustrated in FIG. 5.

FIG. 5 is a sequence diagram illustrating an example of a process in which the information processing system according to the present embodiment records an execution time of a report generating container in association with a tenant ID, according to the present embodiment. In the following description of the present embodiment, the user operates the user terminal 14 to access the report generation service providing server 30.

The user accesses the report generation service providing server 30, and the display 506 displays a UI provided by the UI unit 80 of the report generation service providing server 30. In step S10, the user operates the keyboard 511 or the pointing devices 512 of the user terminal 14 to issues a report generation request via the UI displayed on the display 506 of the user terminal 14.

In step S12, the container control unit 82 of the report generation service providing server 30 that has received the report generating request transmitted from the user creates the report generating container 22 in the application execution environment 20. In addition, the container control unit 82 transmits a report generating request, which is corresponding to, or the same as, the report generating request transmitted in step S10, for causing the created report generating container 22 to generate a report associated with a tenant ID specified with the report generating request transmitted in step S10.

The report generating container 22 generates the report based on the apparatus operation data associated with the tenant ID specified by the report generating request transmitted in step S10 among all of the operation date of the apparatus 12 held by, or stored in, the apparatus operation data collecting server 28. When the report generation is completed, the report generating container 22 transmits a report generation completion notification to the report generation service providing server 30.

In step S16, the container control unit 82 of the report generation service providing server 30 discards, or deletes, the report generating container 22 that is a transmission source of the report generation completion notification. In step S18, the container execution time recording request unit 84 of the report generation service providing server 30 causes the container execution time collecting server 26 to record a period of time (execution time) during which the report generating container 22, which is discarded in step 516, executes processing in the application execution environment 20 in association with the tenant ID. For example, the execution time during which the report generating container 22, which is discarded in step S16, is executing the processing in the application execution environment 20, may be obtained by measuring a time from when the report generating container 22 is created in step S12 to when the report generating container 22 is discarded in step 516.

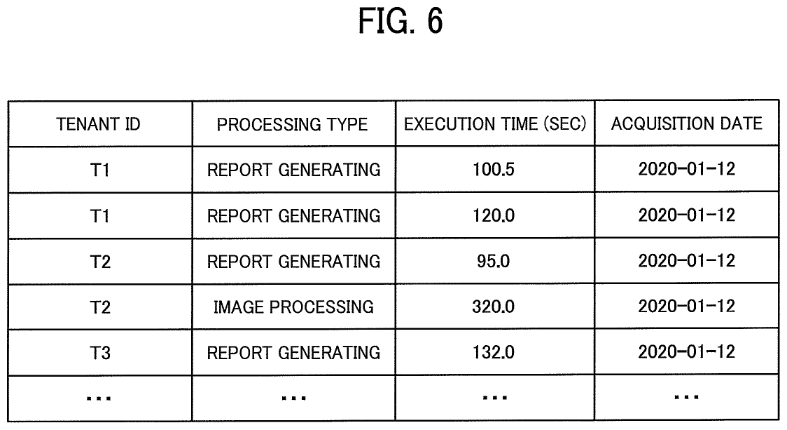

The container execution time collection server 26 records the container execution time (execution time) in a table as illustrated in FIG. 6, for example. FIG. 6 is a diagram illustrating an example of a table recorded by the container execution time collection server 26, according to the present embodiment.

The table illustrated in FIG. 6 includes one or more records each of which has data items of “TENANT ID,” “PROCESSING TYPE,” “EXECUTION TIME,” AND “ACQUISITION DATE.” The data item of “PROCESSING TYPE” is information for identifying a type of processing executed by the container 56 in the application execution environment 20. For example, in the case of the report generating container 22, “REPORT GENERATING” is recorded as the processing type. When an image processing container is created in the application execution environment 20, and 62 the processing is executed, “IMAGE PROCESSING” or the like is recorded as the processing type.

The data item of “EXECUTION TIME” is a period of time during which the container 56 executes processing in the application execution environment 20. The data item of “ACQUISITION DATE” is an acquisition date of the information of a record recorded in the table of FIG. 6, and indicates, for example, a date on which the report generating container 22 executes the processing in the application execution environment 20.

According to the table of FIG. 6, the container execution time collection server 26 records, in association with the corresponding tenant ID, the execution time, which is a period of time from when the report generating container 22 is created in the application execution environment 20 and to when the report generating container 22 is discarded.

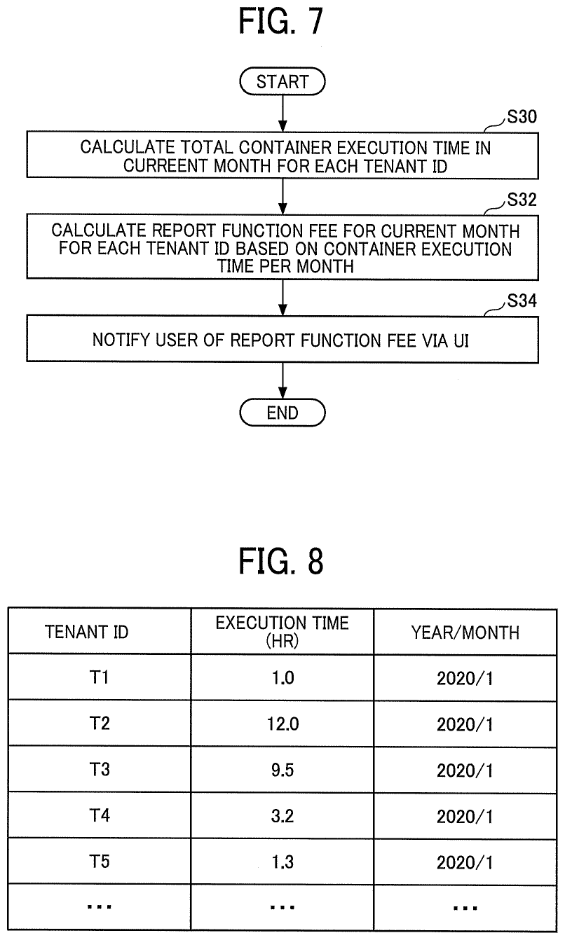

In the information processing system according to the present embodiment, the fee for the report function is calculated, for example, by performing a process illustrated in FIG. 7. FIG. 7 is a flowchart illustrating an example of a process in which the information processing system calculates a fee for the report function for each tenant ID, according to the present embodiment. The processing of the flowchart illustrated in FIG. 7 may be automatically performed at the beginning of a month or may be performed in response to a request from a user.

In step S30, the container execution time calculation unit 86 of the report generation service providing server 30 calculates, for example, an execution time (total execution time) of the report function in a current month for each tenant ID based on the execution time recorded by the container execution time collection server 26 in association with the tenant ID. The execution time (total execution time) of the report function in the current month for each tenant ID is to be used to calculate a fee for the report function of the corresponding tenant ID for the current month. The fee for the report function may be referred to as a report function fee.

FIG. 8 is a diagram illustrating an example of a table of an execution time (total execution time) of the report function of a current month calculated by the container execution time calculation unit. The table illustrated in FIG. 8 includes one or more records each of which includes data items of “TENANT ID,” “EXECUTION TIME,” AND “YEAR/MONTH.” The data item of “YEAR/MONTH” is an example of a predetermined period during which a report is generated as appropriate. As illustrated in the table of FIG. 8, the container execution time calculation unit 86 calculates and records, for example, the execution time (total execution time) of the report function of the current month for each tenant ID based on the execution time recorded in association with the tenant ID by the container execution time collection server 26.

In step S32, the fee calculation unit 88 calculates, for example, a fee for the report function (report function fee) for the current month for each tenant ID based on, for example, the execution time (total execution time) of the report function of the current month calculated in step S30. In other words, an amount value corresponding to the usage of the report function in the current month is obtained for each tenant ID. Then, in step S34, the UI unit 80 presents the fee for the report function (report function fee), namely the amount value, for, for example, the current month calculated, or obtained, in step S32 to the user terminal 14 via the UI.

As described above, according to the present embodiment, the fee for the report function, which uses the application execution environment 20 in which processing is manages by units of containers, is calculated based on the execution time of the report generating container 22, and thereby, a fee calculated according to a usage pattern of the service for each user is obtainable.

For example, in the report function of the usage record of the apparatus 12, the execution time (total execution time) of the report generating container 22 in the predetermined period such as a current month changes depending on a data amount and a collection method (usage amount for each user, each apparatus, or the like). In addition, depending on use frequency of the report function, the execution time (total execution time) of the report generating container 22 in the predetermined period such as the current month changes.

The information processing system according to the present embodiment may set to calculate a high fee for a report function of an organization that takes time to generate a report, and may set to calculate a high fee for a report function of an organization that frequently generates a report. The information processing system according to the present embodiment may set to calculate a low fee for a report function of an organization that does not take time to generate a report, and may set to calculate a low fee for a report function of an organization that does not frequently generate a report.

The information processing system according to the present embodiment that calculates a fee according to an execution time of the report generating container 22 reduces user dissatisfaction in relation to a fixed-rate charging system.

Each of the functions of the described embodiments may be implemented by one or more processing circuits or circuitry. Processing circuitry includes a programmed processor, as a processor includes circuitry. A processing circuit also includes devices such as an Application Specific Integrated Circuit (ASIC), a Digital Signal Processor (DSP), a Field Programmable Gate Array (FPGA), and conventional circuit components arranged to perform the recited functions.

The apparatuses or devices described in the above-described embodiment are merely one example of the plural computing environments that implement the embodiments disclosed herein.

For charging for a fee for usage of a service such as a report function, for example, a fixed-rate charging system in which a service is provided at a fixed fee per fixed period is used. With the fixed-rate charging system, a user is charged a fixed fee for each fixed period to use the service such as the report function even when the user does not use the service in a certain period, and this may cause dissatisfaction in the user. In addition, there is a case where a plurality of charging plans is prepared in accordance with usage patterns. In such a case, the user selects one of the plurality of charging plans to be set, and this may cause dissatisfaction in the user.

According to the above-described embodiment, the information processing system that calculates a fee for a service according to a usage pattern of a user is provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An information processing device, comprising circuitry configured to:
create, in an application execution environment, a container to provide a service, the application execution environment being used to provide the service and managed in a unit of one container;
cause the container to execute processing to provide the service;
cause another device to record an execution time in association with identification information of a user group, the execution time being a period of time during which the container executes the processing; and
obtain an amount value corresponding to usage of the service for the user group based on the execution time associated with the identification information of the user group.

2. The information processing device of claim 1, wherein
the circuitry causes the container to execute the processing to generate a report in relation to a usage record of an apparatus associated with the identification information of the user group.

3. The information processing device of claim 1, wherein
the circuitry further causes the another device to record information on a type of processing executed by the container in association with the execution time and the identification information of the user group.

4. The information processing device of claim 1, wherein
the circuitry causes the container to execute the processing to generate a report in relation to a usage record of an apparatus associated with the identification information of the user group based on apparatus operation data, the apparatus operation data being data on an operating status of the apparatus and associated with the identification information of the user group.

5. An information processing system, comprising:
the information processing device of claim 1;
an execution time collection device including execution time collection device circuitry configured to record the execution time to be transmitted to the information processing device; and
an apparatus operation data collection device including apparatus operation data collection device circuitry configured to collect apparatus operation data, the apparatus operation data being data on an operating status of an apparatus associated with the identification information of the user group, the apparatus being communicably connected to the information processing device, the execution time collection device, and the apparatus operation data collection device via a network.

6. A non-transitory recording medium storing a plurality of instructions which, when executed by one or more processors, causes the processors to perform a method, the method comprising:
creating, in an application execution environment, a container to provide a service, the application execution environment being used to provide the service and managed in a unit of one container;
causing the container to execute processing to provide the service;
causing a device to record an execution time in association with identification information of a user group, the execution time being a period of time during which the container executes the processing; and
obtaining an amount value corresponding to usage of the service for the user group based on the execution time associated with the identification information of the user group.

7. An information processing method, comprising:
creating, in an application execution environment, a container to provide a service, the application execution environment being used to provide the service and managed in a unit of one container;
causing the container to execute processing to provide the service;
causing a device to record an execution time in association with identification information of a user group, the execution time being a period of time during which the container executes the processing; and
obtaining an amount value corresponding to usage of the service for the user group based on the execution time associated with the identification information of the user group.
